(19) United States
(12) Patent Application Publication
(10) Pub. No.: US 2017/0274430 A1
(43) Pub. Date: Sep. 28, 2017

(54) Downspout Cleaning Method

(71) Applicant: Ronald Brick, Winnipeg (CA)

(72) Inventor: Ronald Brick, Winnipeg (CA)

(21) Appl. No.: 15/463,393

(22) Filed: Mar. 20, 2017

Related U.S. Application Data
(60) Provisional application No. 62/312,163, filed on Mar. 23, 2016.

(51) Int. Cl. B08B 9/032; A01G 1/12; A47L 5/14

(52) U.S. Cl. CPC B08B 9/0328; A47L 5/14; A01G 1/125

(57) ABSTRACT

A system for cleaning a downspout of an eavestrough system where the downspout comprises a downwardly extending pipe with a bottom discharge portion having a mouth utilizes an air blower system which can be a leaf blower or a shop vacuum with an outlet nozzle. The system includes a connector portion in the form of a flexible sleeve having first and second open ends and a tightening system such as a strap at each end. In use the first end is tightened onto the outlet nozzle of the air blower and the second end is tightened onto the discharge portion at the mouth and the air blower system is operated to drive air through the downspout to expel any collected materials.

This invention relates to a method of cleaning a downspout of an eavestrough system.

The arrangement of the present invention is designed for cleaning eavestrough down spout pipe.

According to the invention there is provided a method for cleaning a downspout of an eavestrough system where the downspout comprises a downwardly extending pipe with a bottom discharge portion having a mouth, the method comprising:

providing an air blower system with an outlet nozzle;

providing a connector portion comprising a sleeve having first and second open ends and a tightening system at each end;

tightening the first end onto the outlet nozzle and tightening the second end onto the discharge portion at the mouth;

and operating the air blower system to drive air through the downspout to expel any collected materials.

Preferably the tightening system comprises a strap which is attached to the sleeve at the respective end and wraps around the end to pull the end tight. However other tightening systems can be used

Preferably the tightening system comprises a hook and loop fastening to pull the strap tight around the sleeve.

Preferably the sleeve is a straight cylindrical flexible member with no bends or junctions. However longer or more complex arrangements can be provided.

Preferably the sleeve is formed from a fabric. However other materials can be used. The use of fabric allows the sleeve to be slightly oversized to slip easily onto the coupling at each end and to be pulled tight by a simple strap.

In one arrangement the air blower system is a leaf blower and the outlet is a rigid pipe extending outwardly from a body of the leaf blower.

In another arrangement the air blower system is a shop vacuum and the outlet is a flexible hose.

This arrangement of the present invention will lead people away from climbing up ladders to clean their eaves troughs and pipes.

How the sleeve or hose works: The hose is connected to the downspout pipe on ground level and a leaf blower or a shop-vac is connected to the other end. The leaf blower or shop-vac is turned on and the air pushes through the hose and will blow out any debris out of the down spout pipe. Doing this procedure 2-5 times a season will keep the down spout pipe clean and this will allow water to flow.

The arrangement of the present invention can provide a sleeve which is typically 3 feet long with adjustable ends which can be tightened for example by the strap system so there is a tight fit at either end of the order of 4 inches in diameter to surround the outlet and to surround the end of the downspout.

The arrangement of the present invention in use now is 3 feet long×4 inches in diameter with Velcro straps at each end for strapping the hose to the eavestrough down spout pipe.

The arrangement of the present invention provides a hose which also can be provided in lengths from 2 feet long to 5 feet long with 4 inch diameter with Velcro straps at each end.

The arrangement of the present invention can also be left hooked up to the down spout pipe when the air blower is removed for other uses.

Another arrangement of the present invention there is provided a hose which is made for commercial buildings, where the hose can be provided in lengths of for example 5 feet to 10 feet long with 10 inch diameter with Velcro straps at each end.

The sleeve can be formed from different materials such as Vinyl, canvas or rubber, so that the sleeve is flexible and collapsible with Velcro straps at each end for adjusting.

### BRIEF DESCRIPTION OF THE DRAWINGS

One embodiment of the invention will now be described in conjunction with the accompanying drawings in which:

FIG. 1 is a cross-sectional view through a cleaning system according to the present invention using a shop vacuum system and a flexible sleeve to connect to the downspout.

FIG. 2 is an isometric view of the flexible sleeve of FIG. 1.

FIG. 3 is a side elevational view of a system similar to that of FIG. 1 using a leaf blower.

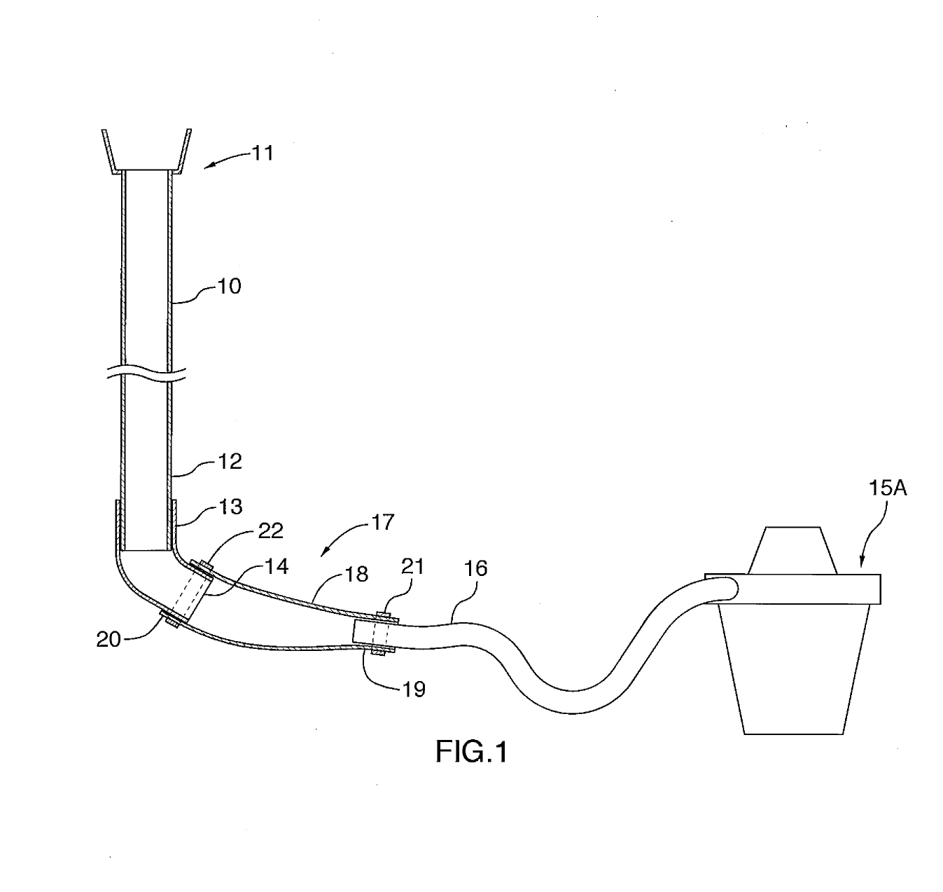

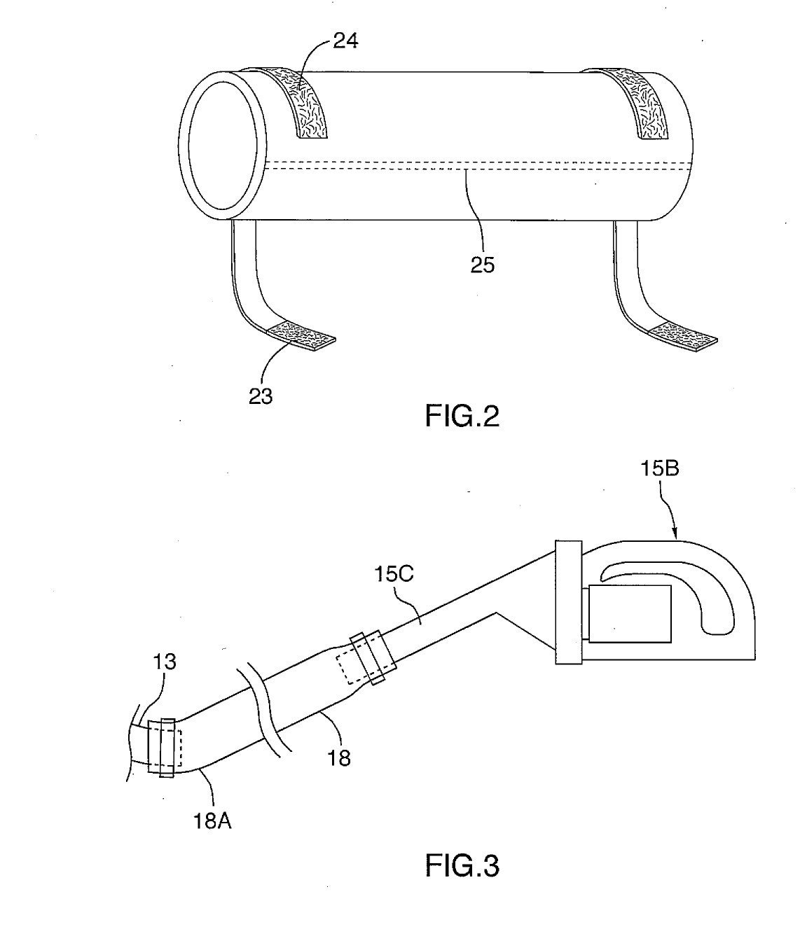

In the drawings like characters of reference indicate corresponding parts in the different figures.

### DETAILED DESCRIPTION

The method for cleaning a downspout 10 of an eavestrough system 11 is provide where the downspout 10 comprises a downwardly extending pipe 12 with a bottom discharge portion 13 having a mouth 14.

The method comprises providing an air blower system 15A in the form of a shop vacuum system 15A with a flexible outlet nozzle 16. A connector portion 17 comprising a sleeve 18 having first and second open ends 21, 22 and a tightening system in the form of a strap 21, 22 at each end. In operation the sleeve is located with its ends surrounding the air supply outlet and the mouth 14 and the first end is tightened onto the outlet nozzle and the second end tightened onto the discharge portion at the mouth by wrapping the straps around the ends of the sleeve and pulling them tight around with the ends of the straps being held by hook and loop fasteners 23, 24.

The air blower system is then operated to drive air through the downspout to expel any collected materials.

The sleeve is a straight cylindrical flexible member formed from a fabric stitched along a line 25.

As shown in FIG. 3 the air blower system can be a leaf blower 15B and the outlet is a rigid pipe 15C extending outwardly from a body of the leaf blower and extends into the sleeve at the lower end. In this case the sleeve 18 can flex to take up the difference in angle between the pipe 15C and the portion 13 of the downspout 12.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for cleaning a downspout of an eavestrough system where the downspout comprises a downwardly extending pipe with a bottom discharge portion having a mouth, the method comprising:
providing an air blower system with an outlet nozzle;
providing a connector portion comprising a sleeve having first and second open ends and a tightening system at each end;
tightening the first end onto the outlet nozzle and tightening the second end onto the discharge portion at the mouth;
and operating the air blower system to drive air through the downspout to expel any collected materials.

2. The method according to claim 1 wherein the tightening system comprises a strap.

3. The method according to claim 1 wherein the tightening system comprises a hook and loop fastening.

4. The method according to claim 1 wherein the sleeve is a straight cylindrical flexible member.

5. The method according to claim 1 wherein the sleeve is formed from a fabric.

6. The method according to claim 1 wherein the air blower system is a leaf blower and the outlet is a rigid pipe extending outwardly from a body of the leaf blower.

7. The method according to claim 1 wherein the air blower system is a shop vacuum and the outlet is a flexible hose.
